(19) United States
(12) Patent Application Publication
(10) Pub. No.: US 2007/0155224 A1
(43) Pub. Date: Jul. 5, 2007

(54) System for connecting the ends of fluid conduits

(76) Inventors: Gerard Marot, Saint Egreve (FR); Florent Janin, Moirans (FR); Alain Ravex, Meylan (FR); Eric Faure, Coublevie (FR); Laurent Allidieres, Uriage Les Bains (FR)

Correspondence Address: AIR LIQUIDE;Intellectual Property, 2700 POST OAK BOULEVARD, SUITE 1800, HOUSTON, TX, 77056, US

(21) Appl. No.: 10/585,171

(22) PCT Filed: Dec. 10, 2004
(86) PCT No.: PCT/FR04/50677

§ 371 Date: Jun. 30, 2006

(30) Foreign Application Priority Data
Jan. 19, 2004 (FR) 0450095

(51) Int. Cl. H01R 3/00

(52) U.S. Cl. 439/491

(57) ABSTRACT

The female part (F) receiving the male part (M) comprises internally a tubular guide (4) with which the male part cooperates in a tight sealing manner (joint 20); the male and female parts respectively comprise at the input thereof a pivoting insulation flap (19; 17) which can open in a sequence when the male part penetrates the female part prior to the opening of the flap valves (15; 9) of the portions of the fluid circuit (13,7). The invention can be used to fill tanks of automobiles with cryogenic fluid, particularly liquid hydrogen.

The present invention relates to systems for connecting the ends of fluid conduits, in particular cryogenic fluid conduits, particularly for liquid fuels, typically liquid hydrogen or liquefied natural gas, for motor vehicles.

Systems for connecting the ends of fluid conduits, particularly conduits for motor vehicle cryogenic fluid, have up until now had complex and intricate configurations in order to provide the required degrees of sealing, particularly employing coupled rotary plug valves.

The subject of the present invention is to propose a connection system which is particularly suited to the filling of liquid hydrogen or liquefied natural gas tanks, with the system having a simple and effective structure and efficiently providing the cold and hot sealing by employing a single axial translation operation which facilitates manual use and/or ready automation.

To this end, according to one feature of the invention, the system for connecting the ends of fluid conduits, in particular conduits for motor vehicle liquid fuel, comprises a female part intended to receive a portion of a male part, the male and female parts each comprising a shutter for closing the fluid conduit, which is normally closed and can be moved into the open position when the system is in the connected configuration, the male and female parts each additionally including an isolation shutter which is normally closed and can be moved into the open position during the introduction of the male part into the female part.

According to other features of the invention:
the female part comprises a tubular guide with which the male part cooperates by sliding in a leaktight manner, typically via a sliding seal at the end of the male part;
the male part has a central mandrel comprising the closure shutter of the fluid supply conduit and engaging by sliding in the tubular guide of the female part;
the male part comprises, to the rear of the sliding seal, at least a first pivoting flap, forming an isolation shutter, cooperating with the end of the tubular guide during the introduction of the male part into the female part;
the tubular guide of the female part comprises a second pivoting flap, forming an isolation shutter, cooperating with the end of the central mandrel of the male part during the introduction of this male part into the female part;
the male part is advantageously configured in the form of a nozzle which can be actuated manually and the female part is advantageously arranged within the body of a motor vehicle in which at least some of the mechanical and/or electrical power is provided by liquid hydrogen or liquefied natural gas.

Other features and advantages of the present invention will emerge from the following description of embodiments, which is given by way of non-limiting example and with reference to the appended drawings, in which:

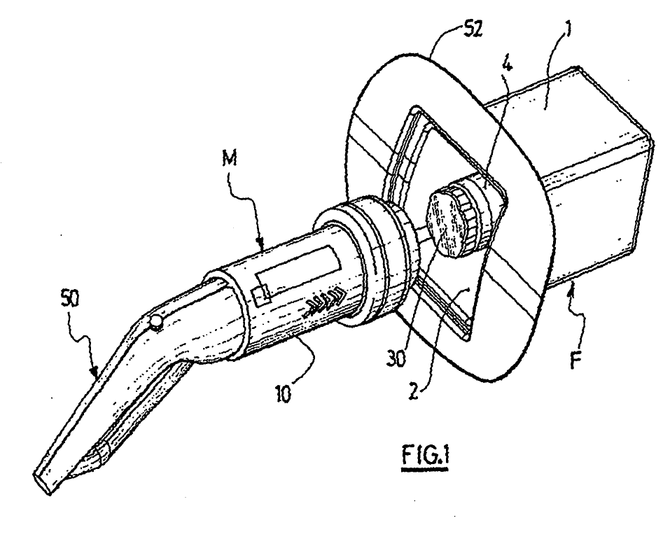

FIG. 1 is a schematic perspective view of a connection system according to the invention prior to interconnection of the male and female parts;

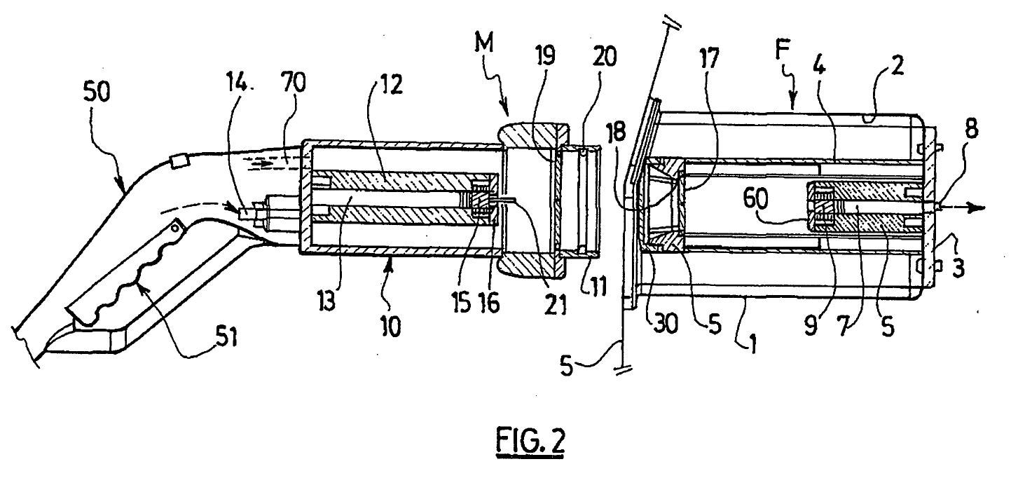

FIG. 2 is a view similar to FIG. 1, but in longitudinal section;

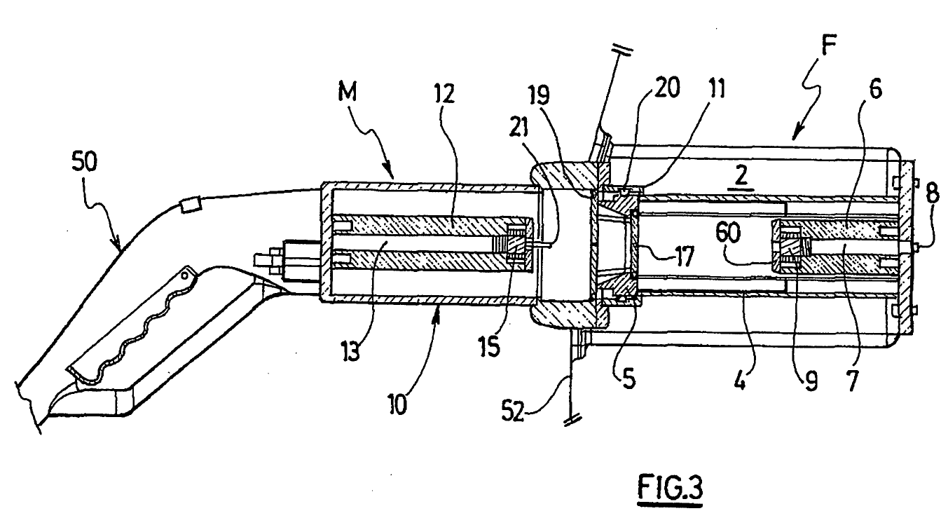

FIG. 3 is a view similar to FIG. 2, showing the male and female parts at the start of interpenetration; and

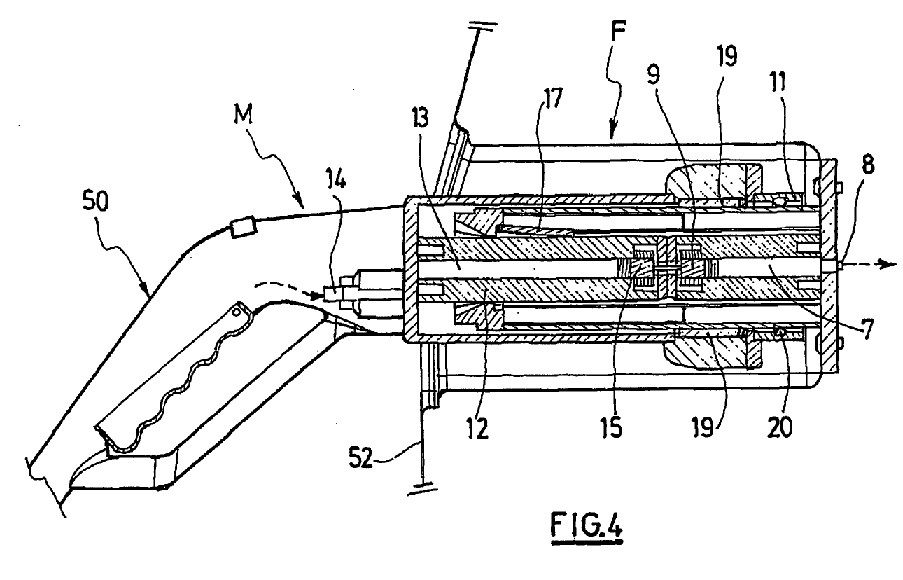

FIG. 4 is a view similar to FIGS. 2 and 3, showing the connection system of the invention in the connected configuration.

FIGS. 1 and 2 depict the main elements of the connection system according to the invention, namely a male part M configured in the form of a nozzle with a hand grip 50 for manual actuation and a trigger 51 for actuating the filling valve, and a female part F, advantageously housed in an element 52 of a vehicle body and comprising a cylindrical casing 1 defining an internal volume 2 intended to receive the male part M.

As can be seen more clearly from FIG. 2, the female part comprises a tubular guide 4 mounted in cantilever fashion on a back plate 3 which closes the casing 2 toward the rear, this tubular guide comprising an annular end-piece 5 and accommodating a coaxial tubular element 6 which internally defines a fluid conduit 7 connected, via an outlet stub 8, to a liquid fuel tank (not shown) of a vehicle. The conduit 7 is normally closed at its front end by a shutter 9 loaded axially by a spring against a seat formed by an annular piece 60 at the front end of the tubular element 6.

For its part, the male part M comprises an external tubular piece 10 prolonged by a tubular end part 11 and containing a tubular mandrel 12 defining a downstream portion 13 of a filling circuit which is connected, via an upstream line 14, to a pressurized liquid fuel supply circuit (not shown) of the filling station to which the nozzle 50, M belongs. The conduit portion 13 is normally closed downstream by a shutter 15 applied axially and elastically against a seat formed by an annular piece 16 at the end of the mandrel 12.

According to one aspect of the invention, the annular end-piece 5 of the tubular element 4 of the female part F comprises at least one inwardly opening pivoting shutter 17, typically two pivoting shutters in the form of half-disks, to the rear of an axial annular sliding surface 18 intended to receive the mandrel 12 of the male part M. The annular end-part 11 of this male part also comprises at least one inwardly pivoting flap 19, advantageously two flaps or half-disks, to the front of a sliding O-ring seal 20 made of metal or PTFE-type elastomer and intended to cooperate by axial sliding with the periphery of the tubular guide 4 of the female part F.

One of the isolation shutters 9, 15, in this instance the shutter of the male part M in the embodiment represented, comprises a stem 21 forwardly extending beyond the annular end-piece 16.

The procedure for connecting the system according to the invention will now be described in relation to FIGS. 3 and 4.

As can be seen from FIG. 3, the annular end 11 of the male part M is first of all introduced into the female part F by bearing slidingly on the tubular guide 4, with which the sliding annular seal 20 immediately forms a “hot” sealing, that is to say isolating the internal volumes of the part M and of the tubular guide from the surrounding atmosphere.

In the initial configuration shown in FIG. 3, the flaps 17, 19 remain closed. By engaging the male part M further forward in the female part F, the annular end-piece 5 comes to bear axially against the flap 19 of the male part, covering the latter and allowing the mandrel 12 to engage in the tubular guide 4, the mandrel in turn coming to bear against the flap 17 of the female part F so as to open it.

The continued linear engagement of the male part M in the female part F, with the seal 20 sliding over the periphery of the tubular guide 4 and the mandrel 12 sliding in the bearing support 18, brings the axial end-faces of the end-pieces 16 and 60 in contact with one another, thereby limiting the engagement of the male part M in the female part F but with the free end of the stem 21 coming to bear against the shutter 9 and causing the filling shutter 15 to open, the admission of the pressurized liquid fuel into the conduit portion 10 and up to the front face of the inner shutter 9, brought about by actuating the trigger 51, then causing this inner shutter to open and allowing the liquid fuel to pass from the filling conduit 13 into the conduit 8 and as far as the receiving tank of the vehicle.

It can thus be seen that, with the system according to the invention, it is possible by way of a single translational movement for “hot” sealing to be provided by the O-ring seal 20 from the start of connection, after which the isolation shutters 19 and 17 which, in the rest position, normally protect the internal volumes of the male part M and of the female part F, respectively, are opened, thereby bringing the internal “cold” regions of the male and female parts into communication before the shutters 15 and 9 permit the circulation of the pressurized cryogenic fluid, the opening sequences of the flaps and shutters being provided automatically by the simple progressive engagement of the male part in the female part.

The disconnection procedure takes place in exactly the same way, but in reverse, to that described above for the connection procedure.

The arrangement according to the invention allows easy and reliable handling which is readily adaptable to robot control, the hot and then cold sealing taking place in a single translation operation. The cold parts remain isolated from the ambient humidity by virtue of the flaps 17 and 19, thereby avoiding the formation of ice on the cold parts, and may be purged by a neutral gas, typically helium, admitted via a circuit 70 (FIG. 2), with compression/expansion cycles carried out before the passage of the cryogenic fluid, for example again under the control of the trigger 51.

The system according to the invention avoids any leakage of cryogenic liquid to the outside, allows rapid cooling by virtue of the compact constituent elements, limiting thermal line losses, permits immediate disconnection, even when the parts are cold, and allows likewise immediate reuse, if necessary, after disconnection.

The female part F, which is the vehicle-mounted part, has the simplest possible, and therefore low-cost, configuration. In particular, the hot seal 20 is situated on the male part M, i.e. on the filling station side, thereby allows more reliable maintenance of this part. The various structural elements of the male and female parts, together with the flaps 17 and 19, are advantageously made of stainless steel.

As represented in FIGS. 1 and 2, the end of the tubular guide 4 of the female part F is advantageously closed, in the non-connected state, by a clip-on or screw-on plastic cap 30 in order to prevent dust from entering the sliding bearing support 18 of the female part F.

Although the invention has been described by way of a specific embodiment, it is not limited thereto but is open to modifications and variants which will be apparent to a person skilled in the art within the scope of the claims which follow.

1-13. (canceled)

14. A system for connecting the ends of fluid conduits, comprising a female part (F) intended to receive a portion of a male part (M), the male and female parts each comprising a shutter (15; 9) for closing the fluid conduits, which is normally closed and can be moved into the open position when the system is in the connected configuration, the male and female parts each additionally including an isolation shutter (19; 17) which is normally closed and can be moved into the open position during the introduction of the male part into the female part.

15. The system of claim 14, wherein the female part (F) comprises a tubular guide (4) with which the male part (M) cooperates by sliding in a leaktight manner.

16. The system of claim 15, wherein the end (11) of the male part (M) comprises a sliding seal (20) cooperating with the tubular guide (4) of the female part (F).

17. The system of claim 15, wherein the male part (M) has a central mandrel (12) comprising the closure shutter (15) of the fluid supply conduit (13) and engaging by sliding in the tubular guide (4) of the female part (F).

18. The system of claim 15, wherein the male part (M) comprises, to the rear of the sliding seal (20), at least a first pivoting flap (19) capable of cooperating with the end (5) of the tubular guide (4) of the female part (F) during the introduction of the male part into the female part.

19. The system of claim 17, wherein the tubular guide (4) of the female part (F) comprises a second pivoting flap (17) capable of cooperating with the end of the central mandrel (12) of the male part (M) during the introduction of this male part into the female part (F).

20. The system of claim 6, wherein the tubular guide (4) of the female part (F) comprises, to the front of the second flap (17), an annular part (5) cooperating by sliding with the periphery of the central mandrel (12) of the male part (M).

21. The system of claim 15, wherein the female part (F) comprises, in the back of the tubular guide (4), a central tubular element (6) comprising the closure shutter (9) of the fluid-receiving conduit (7) and forming an axial stop for the male part.

22. The system of claim 21, in its appendance to one of claims 4 to 7, wherein one of the closure shutters (15; 9) is rigidly secured to a stem (21) cooperating in an axially butting manner with the other closure shutter when the system is in the connection configuration.

23. The system of claim 15, wherein the end of the tubular guide (4) of the female part (F) is able, at rest, to be closed off by a removable cap (30).

24. The system of claim 14, wherein the male part (M) is configured in the form of a nozzle (50) which can be actuated manually.

25. The system of claim 14, wherein the female part (F) is arranged within the body (52) of a motor vehicle.

26. The system of claim 14, wherein the fluid is liquid hydrogen or liquefied natural gas.
